(19) United States
(12) Patent Application Publication
(10) Pub. No.: US 2025/0293638 A1
(43) Pub. Date: Sep. 18, 2025

(54) Large Scale Solar Energy Storage System-Based Advanced Materials

(71) Applicant: University of Cincinnati, Cincinnati, OH (US)

(72) Inventor: Ahmed Elgafy, Centerville, OH (US)

(73) Assignee: University of Cincinnati, Cincinnati, OH (US)

(21) Appl. No.: 19/078,420

(22) Filed: Mar. 13, 2025

Related U.S. Application Data
(60) Provisional application No. 63/564,531, filed on Mar. 13, 2024.

(51) Int. Cl. H02S 40/44; F24S 10/00; F24S 60/10; H02S 10/20

(52) U.S. Cl. CPC H02S 40/44; F24S 10/00; F24S 60/10; H02S 10/20

(57) ABSTRACT

A system for collecting and storing solar energy is provided. The system includes one or more solar collectors, a storage medium, a storage space, a water source, one or more water pumps, and one or more solar photo voltaics. The storage medium is a phase change material (PCM) and carbon nanofibers (CNFs).

### CROSS-REFERENCE TO RELATED APPLICATIONS

This application claims priority to U.S. Provisional Application Ser. No. 63/564,531, filed Mar. 13, 2024, which application is hereby incorporated by reference in its entirety.

### TECHNICAL FIELD

The present invention relates to materials for solar energy storage.

### BACKGROUND OF THE INVENTION

This section is intended to introduce the reader to various aspects of art that may be related to various aspects of the present invention, which are described and/or claimed below. This discussion is believed to be helpful in providing the reader with background information to facilitate a better understanding of various aspects of the present invention. Accordingly, it should be understood that these statements are to be read in this light, and not as admissions of prior art.

As stated by Spencer Dale, BP chief economist, “There is a growing mismatch between societal demands for action on climate change and the actual pace of progress, with energy demand and carbon emissions growing at their fastest rate for years. The world is on an unsustainable path.” Based on various United Nations sources, there are eight main effects of Global Warming: hotter temperatures, more severe storms, increased drought, a warming, rising ocean, loss of species, not enough food, more health risks, and poverty and displacement. In his speech during the 2022 United Nations Climate Change Conference, Mr. John Kerry, the U.S. Special Presidential Envoy for Climate emphasized that we must keep the temperature rise within 1.5° C. as outlined in the Paris Agreement. To keep the temperature rise within 1.5° C. as outlined in the Paris Agreement and prevent the worst impacts of climate change, the world will need to reach net-zero carbon emissions (as solar or wind energies) by around midcentury.

### SUMMARY OF THE INVENTION

Certain exemplary aspects of the invention are set forth below. It should be understood that these aspects are presented merely to provide the reader with a brief summary of certain forms the invention might take and that these aspects are not intended to limit the scope of the invention. Indeed, the invention may encompass a variety of aspects that may not be explicitly set forth below.

In one aspect of the present invention, a system for collecting and storing solar energy is provided. The system includes one or more solar collectors, a storage medium, a storage space, a water source, one or more water pumps, and one or more solar photo voltaics. The storage medium is a phase change material (PCM) and carbon nanofibers (CNFs).

In one embodiment, the solar collectors are solar flat plate collectors. In another embodiment, the storage space is greater than 100 m³. In one embodiment, the one or more water pumps are powered by one or more of the solar photo voltaics. In another embodiment, the PCM has a melting point from 45-75° C. In one embodiment, the PCM is paraffin wax.

In another embodiment, the storage medium comprises a mass ratio of CNFs to PCM from 1 to 10%. In one embodiment, the CNFs have an average diameter from 70-200 nm. In another embodiment, the CNFs have an average length from 50-100 nm. In one embodiment, the CNFs are high heat treated. In another embodiment, the CNFs have a hollow cylinder structure with a double-wall outer structure. In one embodiment, the storage medium consists essentially of a phase change material (PCM) and carbon nanofibers (CNFs).

### BRIEF DESCRIPTION OF THE DRAWINGS

The objects and advantages of the disclosed invention will be further appreciated in light of the following detailed descriptions and drawings in which:

FIG. 1 is a schematic showing a basic layout for a large-scale solar energy storage system using nanocomposite to store solar energy according to the present invention. In one embodiment, it is used during both summer season and winter season.

FIG. 2 is a schematic showing a basic layout for a small-scale solar energy storage system according to the present invention.

### DEFINITIONS

As used herein, the term “about,” when referring to a value or to an amount of mass, weight, time, volume, pH, size, concentration or percentage is meant to encompass variations of +20% in some embodiments, +10% in some embodiments, +5% in some embodiments, +1% in some embodiments, +0.5% in some embodiments, and +0.1% in some embodiments from the specified amount, as such variations are appropriate to perform the disclosed method.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In many parts of the world, direct solar radiation is one of the most potential sources of energy. However, the large-scale utilization of this form of energy is possible only if the effective technology for its storage can be developed with acceptable capital and running costs. As a result, for the urgent need to store solar energy, the design of a new generation of solar energy storage systems has grown in importance.

The nature of solar energy, radiant thermal energy, magnifies the role and usage of thermal energy storage, (TES), techniques. Thermal energy can be stored as a change in internal energy of a material as sensible heat, latent heat or combination of these techniques. One of prospective techniques of storing solar energy in form of thermal energy is the application of Phase Change Materials, PCMs.

A phase-change material (PCM) is a substance with a high heat of fusion, which, by melting and solidifying at a certain temperature, is capable of storing and releasing large amounts of energy. Heat is absorbed or released when the material changes from solid to liquid and vice versa. The phase change of PCMs falls into the category of moving boundary problems. During their phase change process, both liquid and solid phases are presented and separated by a moving interface, mushy region. PCMs store energy in both sensible and latent heat forms. Paraffin waxes are used as PCMs for thermal storage applications due to their desirable characteristics such as: high latent heat of fusion, chemically inert and stable, no phase segregation and commercially available at low cost.

However, it is very challenging to find an ideal PCM that satisfies all the desirable properties. PCMs, like paraffin waxes, have some inherent limitations, such as low thermal conductivity which reduces the heat exchange rate during phase change process. Many techniques were developed to enhance the thermal performance of paraffin waxes, such as using metal fillers, but such techniques add more weight or volume and cost.

The present invention uses nanocomposites to enhance the thermal performance of a Phase Change Material. Carbon nanofibers (CNFs) are added into a PCM, such as paraffin wax, to form a new nanocomposite to enhance its thermal performance during its phase change. In one embodiment, the PCM has a melting point from 45-75° C. In another embodiment, the CNFs are High Heat Treated (HHT). In one embodiment, the CNFs have a hollow cylinder structure with a double-wall outer structure. In another embodiment, the CNFs have an average diameter from 70-200 nm. In one embodiment, the CNFs have an average diameter of 100 nm. In another embodiment, the CNFs have an average length from 50-100 nm. In one embodiment, the mass ratio of CNF to PCM is from 1-10%.

In one embodiment, the present invention enables robust large scale solar energy storage system-based advanced materials and nanocomposites to store solar energy during spring and summer seasons. The stored solar energy can then be used during the fall and winter seasons. In one embodiment, the system of the present invention is powered by solar energy to ensure using only clean energy. This invention is designed to fulfill the needs of clean energy usage (as providing hot water) for a city, county, or even a state without using fossil fuels.

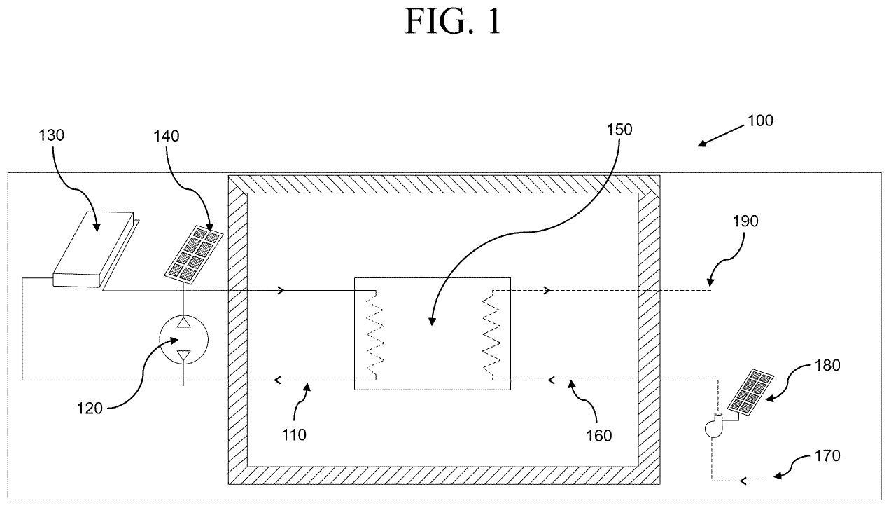

The storage material of the present invention is made from advanced materials, nanocomposites, that are able to store enormous amount of heat energy. For example, large amounts of heat energy can be stored when heat is plentiful in the summer season. This can be achieved by providing energy by means of, for example, solar flat plate collectors as shown in FIG. 1. Alternatively, other types of solar collectors may be used. For example, evacuated tube collectors, line focus collectors or point focus collectors can be used. The fluid flowing through the collector will be circulated by means of pumps that may be powered by a solar photo voltaic (“PV”) system to ensure using only solar energy in the system. During the winter season, the stored energy in the nanocomposite material will be used to heat the water that is circulated by means of pumps that are powered by solar PV system. The hot water will be available for domestic usage (for a city, county, or even a state according to the system capacity).

Regarding FIG. 1, water is circulated in a closed loop 110 using a pump 120 powered by a solar PV system 140. The water is circulated within a solar collector 130, heating the water. The heated water is circulated to a storage material comprising a nanocomposite 150, where the storage material is heated. This water is then circulated back to the solar collector 130 via the closed loop 110.

The heat is utilized via a water circulation system 160 with a second pump powered by a solar PV system 180. The water circulation system 160 intakes cold water 170 and circulated it within the heated storage material 150. This heats the cold water. The heated water is then circulated out of the system 190 for typical uses such as domestic hot water.

### System Components

In one embodiment, basic components for the system of the present invention include solar flat plate collectors, a storage medium, a large storage space, a water source, water pumps and a solar photo voltaic. The solar flat plate collectors are used to provide solar energy to the storing materials (nanocomposite). In one embodiment, the storage medium is a nanocomposite based PCM and carbon nanofibers. The large storage space is used to encompass the storage medium and metal pipes for circulating water. A water source is used to transmit the heat from/through the pipes. Water pumps provide the force to transmit the water from/through the pipes. In addition, solar photo voltaic (“PV”) systems are used to power the pumps.

Regarding the size of the storage space, it depends mainly on the required amount of solar energy to be stored. The size of the storage space may vary according to the needs for a home/multiple homes in complex/city, for example. In one embodiment, the large storage space is greater than 100 m³.

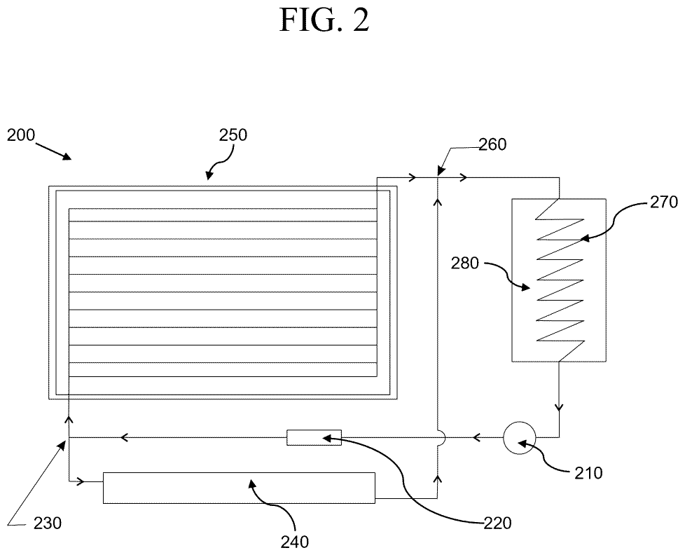

FIG. 2 shows an example of a basic layout for a small-scale solar energy storage system 200 according to the present invention. Water is circulated through a system 200 using a pump 210. The water is directed through a flow meter 220 to a first three-way valve 230. The water can be directed from the first three-way valve 230 to a radiator 240 and/or a solar panel 250. The water passing by the solar panel 250 flows to a second three-way valve 260. The second three-way valve 260 also may direct water that has exited the radiator 240. Water exiting the second three-way valve 260 runs through a heat exchanger 270 located in a storage medium 280. Water exiting the heat exchanger is recirculated in the system using the pump 210.

### EXAMPLES

### Example 1

An embodiment of the nanocomposites of the present invention was tested for use in solar energy storage systems. The design and fabrication of the nanomaterial, storage medium enclosure, heat exchanger, and pumping and plumbing systems were prepared. The storage medium enclosure was a vertical cylindrical enclosure from clear acrylic for visibility with 0.8 m height and 0.1624 m diameter. The heat exchanger was a coil-shaped made of ⅝″ ACR copper tubing with 32 coils and surface area of 0.384 m². A flat plate solar collector was selected to provide solar energy to the storage system. For this example, the PCM is Gulf wax with a melting point of 52° C. The mass ratio of CNF to PCM was 9%. The CNFs are High Heat Treated (HHT) “PR-24” fibers, manufactured by Applied Sciences, Inc. (ASI). Carbon Nanofibers were added to PCM using shear mixing at 125° C. and atmospheric pressure.

To select the pump, several aspects were considered: the mass flow rate of flowing fluid, the material of the plumbing components, the configuration of the tubing, and losses as friction losses. For this particular application, it was determined that a pump with a flow of 1 GPM providing at least 2.1 m of head was needed. A Taco 006 circulation pump was selected. The entire plumbing system was fabricated and assembled with common plumbing tools, such as a pipe cutter, pipe wrench, crescent wrench, torch and solder, Teflon tape, and thread sealant. The new system was tested, demonstrating excessive capacity to store solar energy (see FIG. 2).

Although not described in detail herein, other steps which are readily interpreted from or incorporated along with the disclosed embodiments shall be included as part of the invention. The embodiments that have been described herein provide specific examples to portray inventive elements, but will not necessarily cover all possible embodiments commonly known to those skilled in the art.

What is claimed is:

1. A system for collecting and storing solar energy, the system comprising:
a. one or more solar collectors,
b. a storage medium,
c. a storage space,
d. a water source,
e. one or more water pumps, and
f. one or more solar photo voltaics;
wherein the storage medium comprises a phase change material (PCM) and carbon nanofibers (CNFs).

2. The system of claim 1 wherein the solar collectors are solar flat plate collectors.

3. The system of claim 1 wherein the storage space is greater than 100 m³.

4. The system of claim 1 wherein the one or more water pumps are powered by one or more of the solar photo voltaics.

5. The system of claim 1 wherein the PCM has a melting point from 45-75° C.

6. The system of claim 1 wherein the PCM is paraffin wax.

7. The system of claim 1 wherein the storage medium comprises a mass ratio of CNFs to PCM from 1 to 10%.

8. The system of claim 1 wherein the CNFs have an average diameter from 70-200 nm.

9. The system of claim 1 wherein the CNFs have an average length from 50-100 nm.

10. The system of claim 1 wherein the CNFs are high heat treated.

11. The system of claim 1 wherein the CNFs have a hollow cylinder structure with a double-wall outer structure.

12. The system of claim 1 wherein the storage medium consists essentially of a phase change material (PCM) and carbon nanofibers (CNFs).
